(19) United States
(12) Patent Application Publication
(10) Pub. No.: US 2014/0320430 A1
(43) Pub. Date: Oct. 30, 2014

(54) INPUT DEVICE

(71) Applicant: Alpine Electronics, Inc., Tokyo (JP)

(72) Inventor: Atsushi Takeda, Iwaki (JP)

(73) Assignee: Alpine Electronics, Inc., Tokyo (JP)

(21) Appl. No.: 14/206,854

(22) Filed: Mar. 12, 2014

(30) Foreign Application Priority Data
Apr. 26, 2013 (JP) 2013-093244

(51) Int. Cl. G06F 3/041

(52) U.S. Cl. CPC G06F 3/041
USPC 345/173

(57) ABSTRACT

An input device includes a controller which determines if a user unintentionally touches a touch panel during a hover operation and recognized the hover operation instead of the touch operation when the user's hand or finger moves at a constant distance from the touch panel in time periods before and after the touch period, respectively regardless of detection of a touch on the touch panel.

### PRIORITY CLAIM

This application claims the benefit of Japanese Patent Application Nos. 2013-093244, filed on Apr. 26, 2013, which is incorporated by reference herein in its entirety.

### BACKGROUND

1. Field of the Invention

The present invention relates to an input device that receives or recognizes a touch operation by a user who touches a panel, and a hover operation performed by the user in a space above the panel, but without touching the panel.

2. Description of the Related Art

Japanese Unexamined Patent Application Publication (Translation of PCT Application) No. 2009-543246 discloses a capacitive touch panel that detects coordinates of the user's finger touching the panel and coordinates of the user's finger which is located closely above the touch panel based on a change pattern of capacitance at each of the coordinates.

When the above-described input device that receives a touch operation and a hover operation is applied to a system which is mounted on a movable body such as a vehicle, the user's hand may unintentionally touch the touch panel due to lurches of the movable body when attempting to perform a hover operation, and this may be erroneously received as a touch operation.

Further, when the user attempts to perform a hover operation without paying sufficient attention to a position of the touch panel, the user's hand may unintentionally touch the touch panel, and this may be erroneously received as a touch operation.

### SUMMARY

Accordingly, it is an object of some embodiments of the present invention to provide an input device capable of preventing an unintentional touch of the user's hand on the touch panel from being erroneously received or recognized as a touch operation when the user attempts to perform a hover operation.

According to an aspect of the invention, an input device with a touch panel includes a touch panel controller that outputs detection data that indicates coordinates of a position on the touch panel at which part of a user's body, such as a hand or finger, approaches when a distance between the part of the user's body and the touch panel is within a predetermined length and a degree of distance between the part of the user's body and the touch panel, a touch operation receiving unit that receives or recognizes a touch operation in which the user touches the touch panel, and a hover operation receiving unit that receives a hover operation performed by the user in a space close to a panel surface of the touch panel without touching the touch panel. In the case where the detection data indicates that a touch period during which the part of the user's body touches the touch panel is detected in an approaching period which is a time period during which the distance between the part of the user's body and the touch panel is within a predetermined length, the touch operation receiving unit does not receive the touch operation when the detection data indicates that the distance between the part of the user's body and the touch panel is substantially constant during a time period other than the touch period in the approaching period, and receives the touch operation when the detection data indicates that the distance between the part of the user's body and the touch panel is not substantially constant during a time period other than the touch period in the approaching period. Further, the hover operation receiving unit receives the hover operation when the detection data does not indicate that the touch period is detected in the approaching period.

The input device may be configured such that, in the case where the detection data indicates that the touch period is detected in the approaching period, the hover operation receiving unit receives the hover operation when the detection data indicates that the distance between the part of the user's body and the touch panel is substantially constant during a time period other than the touch period in the approaching period.

According to another aspect of the invention, an input device includes a touch panel controller that outputs detection data that indicates coordinates of a position on the touch panel at which part of a user's body approaches when a distance between the part of the user's body and the touch panel is within a predetermined length and a degree of distance between the part of the user's body and the touch panel, a touch operation receiving unit that receives a touch operation in which the user touches the touch panel, and a hover operation receiving unit that receives a hover operation performed by the user in a space close to a panel surface of the touch panel without touching the touch panel.

In the case where the detection data indicates that a touch period during which the part of the user's body touches the touch panel is detected in an approaching period which is a time period during which the distance between the part of the user's body and the touch panel is within a predetermined length, the touch operation receiving unit does not receive the touch operation when the detection data indicates that the distance between the part of the user's body and the touch panel is substantially constant during a time period other than the touch period in the approaching period and that the position of the part of the user's body in the approaching period moves substantially in one direction, and receives the touch operation when the detection data indicates that the distance between the part of the user's body and the touch panel is not substantially constant during a time period other than the touch period in the approaching period and that the position of the part of the user's body in the approaching period does not move substantially in one direction. Further, the hover operation receiving unit receives the hover operation when the detection data does not indicate that the touch period is detected in the approaching period.

The input device may be configured such that, in the case where the touch period is detected in the approaching period, the hover operation receiving unit receives the hover operation when the detection data indicates that the distance between the part of the user's body and the touch panel is substantially constant during a time period other than the touch period in the approaching period and that the position of the part of the user's body in the approaching period moves substantially in one direction.

According to another aspect of the invention, an input device includes a touch panel controller that outputs detection data that indicates coordinates of a position on the touch panel at which part of a user's body approaches when a distance between the part of the user's body and the touch panel is within a predetermined length and a degree of distance between the part of the user's body and the touch panel, a touch operation receiving unit that receives a touch operation in which the user touches the touch panel, and a hover operation receiving unit that receives a hover operation performed by the user in a space close to a panel surface of the touch panel without touching the touch panel.

In the case where the detection data indicates that a touch period during which the part of the user's body touches the touch panel is detected in an approaching period which is a time period during which the distance between the part of the user's body and the touch panel is within a predetermined length, the touch operation receiving unit does not receive the touch operation when the detection data indicates that the distance between the part of the user's body and the touch panel is substantially constant during a time period other than the touch period in the approaching period and that the position of the part of the user's body does not move in substantially opposite directions in time periods before and after the touch period, and receives the touch operation when the detection data indicates that the distance between the part of the user's body and the touch panel is not substantially constant during a time period other than the touch period in the approaching period and that the position of the part of the user's body moves in substantially opposite directions in time periods before and after the touch period. Further, the hover operation receiving unit receives the hover operation when the detection data does not indicate that the touch period is detected in the approaching period.

The input device may be configured such that, in the case where the touch period is detected in the approaching period, the hover operation receiving unit receives the hover operation when the detection data indicates that the distance between the part of the user's body and the touch panel is substantially constant during a time period other than the touch period in the approaching period and that the position of the part of the user's body does not move in substantially opposite directions in time periods before and after the touch period.

The input device according to the above aspects determines whether or not the user's touch during the hover operation occurred unintentionally on the basis of the fact whether the distance between the part of the user's body and the touch panel is substantially constant in a period other than the touch period, since the distance between the part of the user's body and the touch panel during the hover operation is substantially constant. When the user's touch is determined as being performed unintentionally during the hover operation, the user's touch is not received as a touch operation.

According to the present invention, it is possible to prevent an unintentional touch of the user's hand on the touch panel from being erroneously received as a touch operation when the user attempts to perform a hover operation. In the input device according to the above aspects, the touch panel may be a capacitive touch panel, and the touch panel controller may be configured to output the detection data that includes data of the capacitance change amount of the capacitances, which are disposed at a position of the coordinates in the touch panel, the data indicating a degree of distance between the part of the user's body and the touch panel.

Further, the input device according to the above aspects may be provided for use in electronic devices which include the input device, the display, and the processing unit that performs operation in response to the touch operation and the hover operation received by the user operation receiving unit. The touch panel may be disposed on a screen of the display.

According to the present invention, it is possible to provide an input device capable of preventing an unintentional touch of the user's hand on the touch panel from being erroneously received as a touch operation when the user attempts to perform a hover operation.

### BRIEF DESCRIPTION OF THE DRAWINGS

FIGS. 1A and 1B are block diagrams of a configuration of an information system according to an embodiment of the present invention;

FIG. 2 is a diagram showing a relationship between a distance from a touch panel and a change in capacitance according to an embodiment of the present invention;

FIG. 3 is a flowchart which shows a user operation detection according to an embodiment of the present invention;

FIGS. 4A1, 4A2, 4B1, 4B2, 4C1 and 4C2 are diagrams which show false touch patterns according to an embodiment of the present invention;

FIGS. 5A1, 5A2, 5B1, 5B2, 5C1, 5C2, 5D1, 5D2, 5E1, and 5E2 are diagrams which show processing in the user operation detection according to an embodiment of the present invention; and

FIGS. 6A1, 6A2, and 6B are diagrams which show examples of false touch patterns according to an embodiment of the present invention.

### DETAILED DESCRIPTION

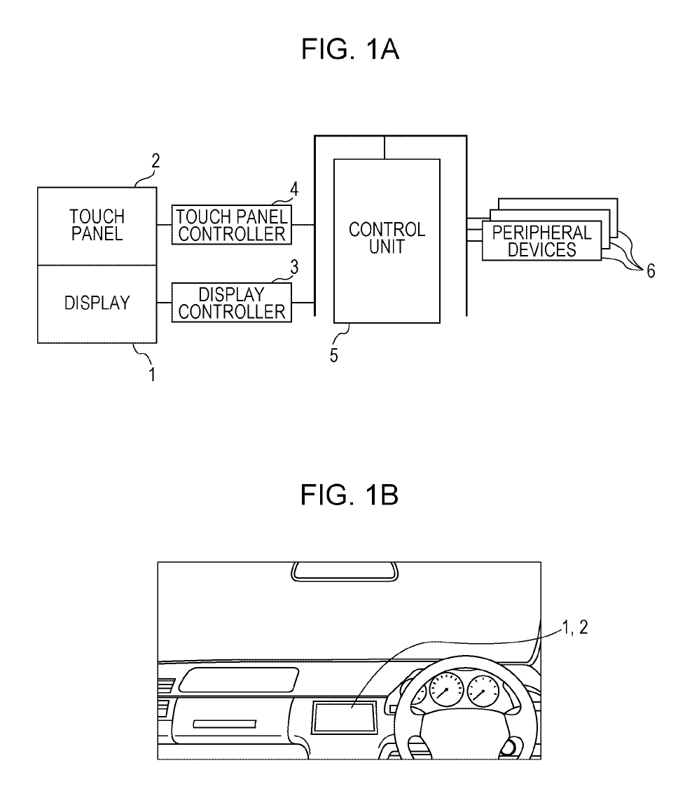

Embodiments of the present invention will be described below by way of example of an information system mounted on a vehicle. FIG. 1A shows a configuration of an information system according to an embodiment of the present invention. The information system described herein may be for use in an audio-video system, a navigation system, or the like. As shown in the drawing, the information system includes a display 1, a touch panel 2, a display controller 3 that controls screen of the display 1, a touch panel controller 4 that controls the touch panel 2, a controller 5 and one or more peripheral devices 6. Such an information system may be formed using a computer which is provided with a CPU, a memory and the like, and in such a configuration, the controller 5 and the peripheral devices 6 may be implemented by the computer executing a specific computer program. The display 1 is, for example, a liquid crystal display unit and is disposed in a dashboard of the vehicle as shown in FIG. 1B. The touch panel 2 is a capacitive touch panel 2 and is disposed on a screen of the display 1. Accordingly, the control unit 5, the touch panel controller 4, the display controller 3, and other components shown in FIG. 1A may include a processor or CPU and memory operatively incorporated into the respective component, or such processor and memory may be separate from the component but operatively coupled thereto.

The touch panel controller 4 actuates the touch panel 2 and detects a capacitance change amount F deviated from a reference value at detection points arranged in a grid pattern on the touch panel 2. The reference value of the capacitance described herein is a capacitance at the detection point in a state that a user's hand or finger does not approach or make actual contact with a surface of the touch panel 2.

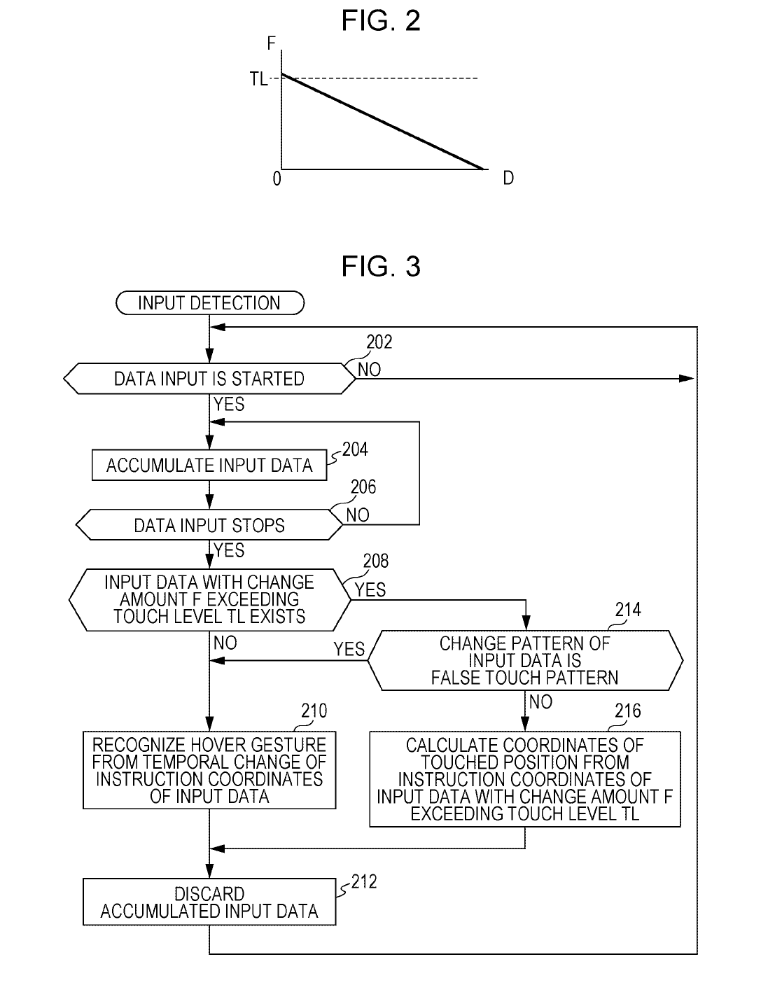

FIG. 2 shows a relationship between a distance D between part of the user's hand or finger and the touch panel 2 and the capacitance change amount F detected by the touch panel controller 4 at the detection points which are immediately below or in close proximity with, the user's hand or finger. As shown in the drawing, the capacitance change amount F increases as the user's hand or finger approaches the touch panel 2, and becomes maximum when the user's hand or finger touches the touch panel 2. The capacitance change amount F varies depending on the vertical distance D, generally, between the user's hand or finger and the touch panel 2, and in addition to that, also varies slightly depending on the conductivity and the like of the user's hand or finger. Accordingly, the capacitance change amount F represents a degree of distance between the user's hand or finger and the touch panel 2. The touch panel controller 4 calculates instruction coordinates (x, y) which are the coordinates of the detection point at which the capacitance changes and the capacitance change amount F at the detection point from the reference value. Then, the touch panel controller 4 outputs data to the controller 5 as input data (x, y, F). The touch panel controller 4 has a sensitivity to detect the change in capacitance when the user's hand or finger is located at a distance of approximately a fraction of a centimeter to as much as 10 centimeters from the touch panel 2.

In one embodiment, only one set of instruction coordinates (x, y) is detected by the touch panel controller 4 at a time. That is, the touch panel controller 4 detects, for example, the coordinates of the detection point at which the capacitance change amount is maximum or the coordinates of the detection point at the center of the distribution area of the detection points at which the capacitance changes as the instruction coordinates (x, y).

Next, a user operation detection performed by the controller 5 in the above configuration will be described. FIG. 3 shows steps of the user operation detection. As shown in the drawing, in this processing, input of the data from the touch panel controller 4 is monitored (step 202). When input of the data is monitored, the input data from the touch panel controller 4 is accumulated (step 204) until input of the data from the touch panel controller 4 is terminated (step 206).

Termination of input of the data from the touch panel controller 4 is determined by detecting termination of input of the data, for example, when input of the data from the touch panel controller 4 is not detected over a predetermined time period (for example, 0.5 seconds). Then, when input of the data from the touch panel controller 4 is terminated (step 206), whether the input data having the capacitance change amount F which exceeds a predetermined touch level TL exists in the accumulated input data (x, y, F) is checked (step 208).

The touch level TL is defined, for example, as shown in FIG. 2, as the minimum value of possible capacitance change amount F when the user's hand or finger touches the touch panel 2 regardless of individual users. Referring back to FIG. 3, when the input data having the capacitance change amount F which exceeds the predetermined touch level TL does not exist in the accumulated input data (x, y, F) (step 208), it is determined that the user is performing a hover operation moving his or her hand above the touch panel 2 without touching the touch panel 2. The user's hand gesture performed above the touch panel 2 is recognized as a hover gesture from a temporal change pattern of the instruction coordinates (x, y) indicated by the accumulated input data (x, y, F) (step 210).

That is, in step 210, it is checked whether the temporal change pattern of the instruction coordinates (x, y) indicated by the accumulated input data (x, y, F) matches any of predetermined input reception gestures such as a right swipe gesture in which the user swipes his or her hand from left to right, a left swipe gesture in which the user swipes his or her hand from right to left, and a right-left swipe gesture in which the user swipes his or her hand right and left, and then, the matched input reception gesture is recognized as the hover gesture performed by the user.

Specifically, when the instruction coordinates (x, y) indicated by the accumulated input data generally moves from left to right over time, the right swipe gesture is recognized as the hover gesture performed by the user. When the instruction coordinates (x, y) indicated by the accumulated input data generally moves from right to left over time, the left swipe gesture is recognized as the hover gesture performed by the user. Further, when the instruction coordinates (x, y) indicated by the accumulated input data generally moves right and left over time in a reciprocating manner, the right-left swipe gesture is recognized as the hover gesture performed by the user.

Once the hover gesture is recognized, the accumulated input data are discarded (step 212), and the process returns to step 202. When the input data having the capacitance change amount F which exceeds the touch level TL exists in the accumulated input data in step 208, whether the change pattern of the accumulated input data corresponds to a predetermined false touch pattern is checked (step 214).

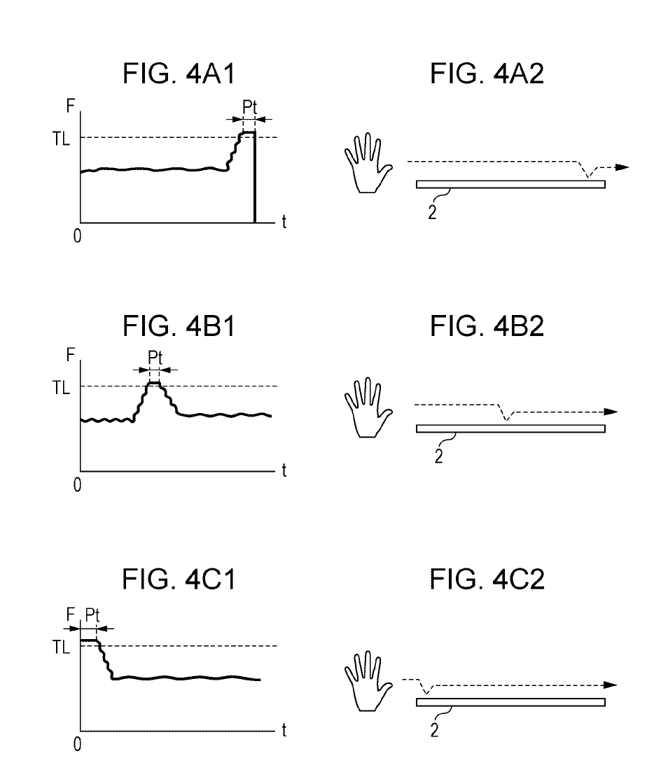

In this embodiment, the false touch patterns are defined as the patterns in which the capacitance change amount F is substantially constant in a time period other than a time period during which the capacitance change amount F exceeds the touch level TL. That is, the false touch patterns correspond to three patterns shown in FIGS. 4A1, 4B1, 4C1. In the pattern shown in FIG. 4A1, the capacitance change amount F indicated by the accumulated input data exceeds the touch level TL only in a time period Pt immediately before input of the data is terminated, and is substantially constant in the remaining time period. The pattern of FIG. 4A1 shows that the user who attempts to perform the hover operation unintentionally touches an end portion of the touch panel 2 due to the vibration of the vehicle or the like at the end of the hover operation as shown in FIG. 4A2. Next, in the pattern shown in FIG. 4B1, the capacitance change amount F indicated by the accumulated input data is substantially constant in the time periods before and after the time period Pt during which the change amount F exceeds the touch level TL. The pattern of FIG. 4B1 shows that the user who attempts to perform the hover operation unintentionally touches a center portion of the touch panel 2 due to the vibration of the vehicle or the like as shown in FIG. 4B2. Next, in the pattern shown in FIG. 4C1, the capacitance change amount F indicated by the accumulated input data exceeds the touch level TL only in the time period Pt immediately after input of the data is started, and is substantially constant in the remaining time period. The pattern of FIG. 4C1 shows that the user who attempts to perform the hover operation unintentionally touches an end portion of the touch panel 2 due to the vibration of the vehicle or the like at the start of the hover operation as shown in FIG. 4C2. Referring back to FIG. 3, when it is determined that the change pattern of the accumulated input data corresponds to the false touch pattern in step 214, the process proceeds to step 210 where the input reception gesture which matches the temporal change pattern of the instruction coordinates indicated by the accumulated input data is recognized as the hover gesture performed by the user. Then, the accumulated input data are discarded (step 212), and the process returns to step 202.

When it is determined that the change pattern of the accumulated input data does not correspond to the false touch pattern in step 214, the instruction coordinates (x, y) indicated by the input data (x, y, F) having the capacitance change amount F which exceeds the touch level TL is calculated as a touch coordinates (step 216). Then, the accumulated input data are discarded (step 212), and the process returns to step 202.

The user operation detection performed by the controller 5 has been described above. According to the above user operation detection, when the change amount F exceeds the touch level TL due to the user unintentionally touching the touch panel 2 during the hover operation as shown in FIGS. 4A2, 4B2, 4C2, the hover operation that the user intended to perform, instead of the touch operation, can be received regardless of occurrence of the capacitance change amount F which exceeds the touch level TL.

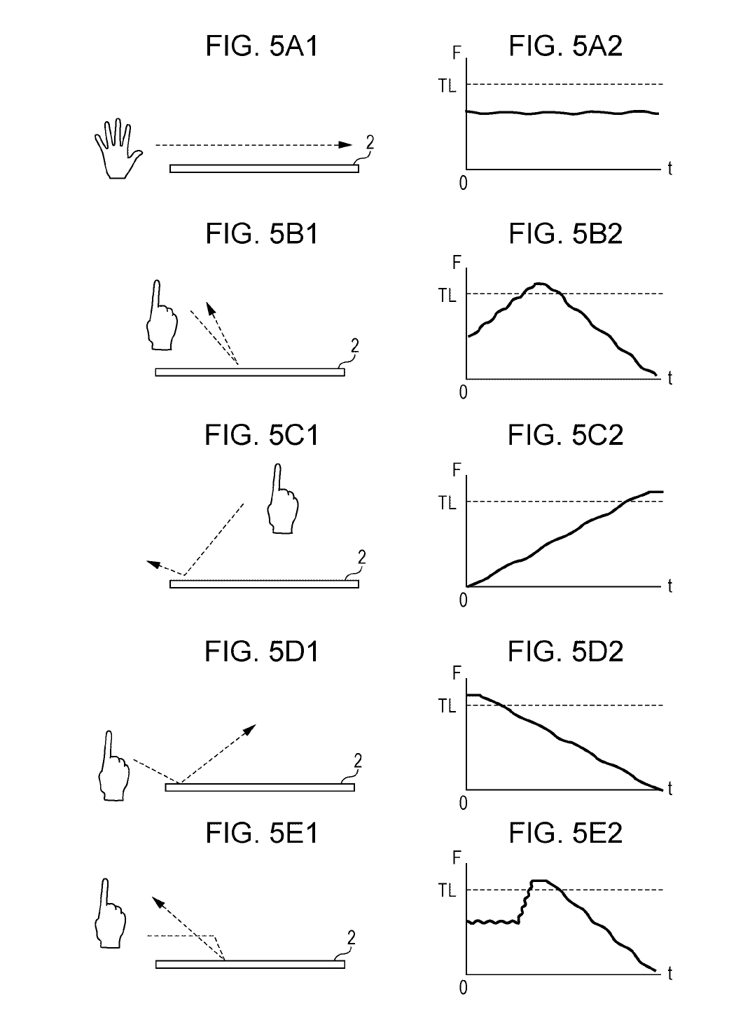

Further, according to the above user operation detection, when the user performs the hover operation above the touch panel 2 as shown in FIG. 5A1, the hover operation can be appropriately received since the capacitance change amount F which exceeds the touch level TL does not exist as shown in FIG. 5A2.

Further, as shown in FIGS. 5B1, 5C1, 5D1, when the user touches the touch panel 2 by performing the touch operation in which the user approaches his or her hand or finger to the touch panel 2 and then moves his or her hand or finger away from the touch panel 2, the capacitance change amount F is not constant in the time period either before or after the time period Pt during which the capacitance change amount F exceeds the touch level TL as shown in FIG. 5B2, 5C2, 5D2. Accordingly, the temporal change pattern of the capacitance change amount F does not correspond to the false touch pattern. Therefore, according to the above user operation detection, when the forgoing user operation is performed, the touch operation can be appropriately received.

Further, as shown in FIG. 5E1, when the user touches the touch panel 2 by performing a touch operation in which the user approaches his or her hand or finger above the touch panel 2 in parallel to the touch panel 2 and then moves his or her hand or finger away from the touch panel 2, the capacitance change amount F is not constant in the time period after the time period Pt during which the capacitance change amount F exceeds the touch level TL as shown in FIG. 5E2. Accordingly, the temporal change pattern of the capacitance change amount F does not correspond to the false touch pattern. Therefore, according to the above user operation detection, when the forgoing user operation is performed, the touch operation can be appropriately received.

Referring back to FIG. 1, when the information system is for use in an audio and visual system, the peripheral devices 6 may be a broadcast receiver, a disk drive that plays a recording disk such as a compact disc and digital versatile disc, an audio output device having a speaker and the like. The controller 5 performs processes such as controlling the operation of the broadcast receiver or the disk drive, outputting the sound received by the broadcast receiver or recorded by the recording disk which is loaded in the disk drive to an audio output device, and outputting an image received by the broadcast receiver or recorded by the recording disk which is loaded in the disk drive to the display 1 in response to the touch coordinates detected by the above user operation detection or the hover gesture recognizes by the above user operation detection while displaying an appropriate GUI screen on the display 1.

Further, when the information system is for use in a navigation system, the peripheral devices 6 may be a storing device that stores map data, a GPS receiver, a sensor that detects a speed or angular speed of a vehicle and the like. The controller 5 performs processes such as calculating the current position, setting a destination, setting a route to the navigation, displaying a navigation image of a map which shows the current position, destination and route on the display 1, and scrolling the navigation image in response to the touch coordinates detected by the above user operation detection or the hover gesture recognizes by the above user operation detection.

Embodiments of the present invention have been described above. According to some of the above embodiments, in the user operation detection, when the temporal change pattern F of the capacitance indicated by the accumulated input data is substantially constant in the time periods before and after the time period Pt during which the change amount F exceeds the touch level TL as shown in FIG. 4B1, the hover operation is received and the touch operation is not received without exception. However, the foregoing embodiment can be modified.

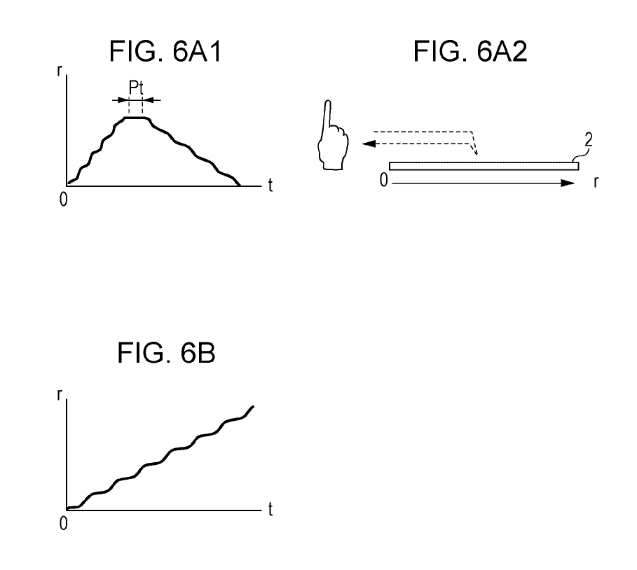

That is, in the case where the temporal change pattern F of the capacitance indicated by the accumulated input data corresponds to the pattern shown in FIG. 4B1, when the temporal change pattern F of the instruction coordinates (x, y) indicated by the accumulated input data shows that the moving direction of the instruction coordinates (x, y) before the time period Pt during which the change amount F exceeds the touch level TL and the moving direction of the instruction coordinates (x, y) after the time period Pt during which the change amount F exceeds the touch level TL are opposite as shown in FIG. 6A1, the touch operation may be received while the capacitance change amount F indicated by the accumulated input data being taken as not corresponding to the false touch pattern. In FIG. 6A1, r represents a distance from the instruction coordinates (x, y) indicated by the input data measured in the moving direction of the instruction coordinates (x, y) indicated by the input data at the start of input of the data before the time period Pt during which the change amount F exceeds the touch level TL.

Accordingly, when the user performs the touch operation in which the user moves his or her hand or finger above the touch panel 2 in parallel to the touch panel 2 to touch the touch panel 2 and then moves back his or her hand or finger in parallel to the touch panel 2 to the original position as shown in FIG. 6A2, the touch operation can be received.

Further, the false touch patterns used in the user operation detection in the above embodiment may be a combination of the patterns shown in FIGS. 4A1, 4B1, 4C1 and the pattern shown in FIG. 6B. The pattern shown in FIG. 6B is a pattern in which the temporal change pattern of the instruction coordinates (x, y) indicated by the accumulated input data shows that the instruction coordinates (x, y) moves in one direction. Further, in FIG. 6B, r represents a distance from the instruction coordinates (x, y) indicated by the input data measured in the moving direction of the instruction coordinates (x, y) indicated by the input data at the start of input of the data.

In the user operation detection, only when the temporal change pattern of the capacitance change amount F indicated by the accumulated input data corresponds to any of the patterns shown in FIGS. 4A1, 4B1, 4C1 and the temporal change pattern of the instruction coordinates (x, y) indicated by the accumulated input data corresponds to the pattern shown in FIG. 6B, the hover operation instead of the touch operation is received while the change pattern of the accumulated input data being taken as corresponding to the false touch pattern.

Accordingly, by using the combination of the touch pattern shown in FIG. 6B and the patterns shown in FIGS. 4A1, 4B1, 4C1, it is possible to identify the unintentional touch on the touch panel 2 during the hover operation shown in FIGS. 4A2, 4B2, 4C2 with more certainty. Further, the user operation detection in the above embodiment may be modified such that, when it is determined that the change pattern of the accumulated input data corresponds to the predetermined false touch pattern in step 214, the process does not proceed to step 210 where the hover gesture is recognized, but proceeds to step 212 where the accumulated input data (x, y, F) are discarded and then returns to step 202. As a consequence, the user's unintentional touch on the touch panel 2 can also be prevented from being received as the touch operation.

The above embodiment may be applied to any information system which includes the touch panel 2 and receives a touch operation and a hover operation, regardless of whether it is mounted on a vehicle or not.

Although preferred embodiments have been described in detail, the present invention is not limited to these specific embodiments of the present invention. Rather, various modifications and changes can be made without departing from the scope of the present invention as described in the accompanying claims. Accordingly, all such modifications are intended to be included within the scope of this invention as defined in the following claims.

What is claimed is:

1. An input device having a touch panel, comprising:
a touch panel controller configured to output detection data that indicates coordinates of a position on the touch panel at which part of a user's body approaches when a distance between the part of the user's body and the touch panel is within a predetermined amount;
a touch operation receiving unit configured to recognize a touch operation in which the user touches the touch panel; and
a hover operation receiving unit configured to recognize a hover operation performed by the user in a space proximate to a surface of the touch panel without touching the touch panel;
wherein, when the detection data indicates that a touch period during which the part of the user's body touches the touch panel is detected in an approaching period defined as a time period during which the distance between the part of the user's body and the touch panel is within a predetermined length, the touch operation receiving unit:
does not recognize the touch operation when the detection data indicates that the distance between the part of the user's body and the touch panel is substantially constant during a time period other than the touch period in the approaching period; and
does recognize the touch operation when the detection data indicates that the distance between the part of the user's body and the touch panel is not substantially constant during a time period other than the touch period in the approaching period; and
the hover operation receiving unit configured to recognize the hover operation when the detection data does not indicate that the touch period is detected in the approaching period.

2. The input device according to claim 1, wherein when the detection data indicates that the touch period is detected in the approaching period, the hover operation receiving unit recognizes the hover operation when the detection data indicates that the distance between the part of the user's body and the touch panel is substantially constant during a time period other than the touch period in the approaching period.

3. An input device having a touch panel, comprising:
a touch panel controller configured to output detection data that indicates coordinates of a position on the touch panel at which part of a user's body approaches when a distance between the part of the user's body and the touch panel is within a predetermined length;
a touch operation receiving unit configured to recognize a touch operation in which the user touches the touch panel; and
a hover operation receiving unit that configured to recognize a hover operation performed by the user in a space close to a panel surface of the touch panel without touching the touch panel;
wherein, when the detection data indicates that a touch period during which the part of the user's body touches the touch panel is detected in an approaching period defined as a time period during which the distance between the part of the user's body and the touch panel is within a predetermined length, the touch operation receiving unit:
does not recognize the touch operation when the detection data indicates that the distance between the part of the user's body and the touch panel is substantially constant during a time period other than the touch period in the approaching period and that the position of the part of the user's body in the approaching period moves substantially in one direction; and
does recognize the touch operation when the detection data indicates that the distance between the part of the user's body and the touch panel is not substantially constant during a time period other than the touch period in the approaching period and that the position of the part of the user's body in the approaching period does not move substantially in one direction, and
the hover operation receiving unit configured to recognize the hover operation when the detection data does not indicate that the touch period is detected in the approaching period.

4. The input device according to claim 3, wherein when the touch period is detected in the approaching period, the hover operation receiving unit recognizes the hover operation when the detection data indicates that the distance between the part of the user's body and the touch panel is substantially constant during a time period other than the touch period in the approaching period, and that a position of the part of the user's body in the approaching period moves substantially in one direction.

5. An input device having a touch panel, comprising:
a touch panel controller configured to output detection data that indicates coordinates of a position on the touch panel at which part of a user's body approaches when a distance between the part of the user's body and the touch panel is within a predetermined length and a degree of distance between the part of the user's body and the touch panel;
a touch operation receiving unit configured to recognize a touch operation in which the user touches the touch panel; and
a hover operation receiving unit configured to recognize a hover operation performed by the user in a space proximate to a surface of the touch panel without touching the touch panel;
wherein, when the detection data indicates that a touch period during which the part of the user's body touches the touch panel is detected in an approaching period defined as a time period during which the distance between the part of the user's body and the touch panel is within a predetermined length, the touch operation receiving unit:
does not recognize the touch operation when the detection data indicates that the distance between the part of the user's body and the touch panel is substantially constant during a time period other than the touch period in the approaching period and that the position of the part of the user's body does not move in substantially opposite directions in time periods before and after the touch period, respectively; and
does recognize the touch operation when the detection data indicates that the distance between the part of the user's body and the touch panel is not substantially constant during a time period other than the touch period in the approaching period, and that the position of the part of the user's body moves in substantially opposite directions in time periods before and after the touch period, respectively; and
the hover operation receiving unit configured to recognize the hover operation when the detection data does not indicate that the touch period is detected in the approaching period.

6. The input device according to claim 5, wherein when the touch period is detected in the approaching period, the hover operation receiving unit recognizes the hover operation when the detection data indicates that the distance between the part of the user's body and the touch panel is substantially constant during a time period other than the touch period in the approaching period, and that the position of the part of the user's body does not move in substantially opposite directions in time periods before and after the touch period, respectively.
